(19) United States
(12) Patent Application Publication
(10) Pub. No.: US 2006/0193603 A1
(43) Pub. Date: Aug. 31, 2006

(54) Information recording and reproducing device

(75) Inventor: Shoji Saito, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/362,391

(22) Filed: Feb. 27, 2006

(30) Foreign Application Priority Data
Feb. 28, 2005 (JP) 2005-054062

(51) Int. Cl. H04N 5/91; H04N 5/445

(52) U.S. Cl. 386/83; 725/58

(57) ABSTRACT

In a second recording extension processing part 16, when it is selected to perform recording extension processing by a first recording extension processing part 15, if bit rate determination means determines, for recorded data subjected to the recording extension processing, that the current recording bit rate is larger than the convertible bit rate and if free space determination means 162 determines that a free space of a recording medium is equal to or larger than the capacity required for recording a TV program for which a timer is programmed, second record means 163 records new data on an area corresponding to the free space of the recording medium. Thus, the recordable time can be increased considering the setting of image quality and sound quality at the time of recording, thus further improving the usability for the user.

This application is based on Japanese Patent Application No. 2005-054062 filed on Feb. 28, 2005, the contents of which are hereby incorporated by reference.

### BACKGROUND OF THE INVENTION

1. Field of the Invention

The present invention relates to an information recording and reproducing device that has a timer programming function of programming a recording for a desired TV program and that performs information recording and reproducing on an optical disc or/and a hard disc as a recording medium.

2. Description of Related Arts

In recent years, optical discs or hard discs, such as CDs (compact discs), DVDs (digital versatile discs), and the like, have been increasingly used for recording pictures, sounds, and the like. Known as information recording and reproducing devices that perform information recording and reproducing on these optical discs are DVD recorders. In addition, known as information recording and reproducing devices that perform information recording and reproducing on the hard disc are hard disc recorders. Further, hard-disc-fitted DVD recorders having a built-in hard disc have become increasingly widespread.

Such information recording and reproducing devices are frequently used for recording TV programs, and the recordable time thereof is not determined only by the capacity of the recording medium such as an optical disc, a hard disc, or the like, but changes depending on the setting (bit rate setting) of image quality and sound quality at the time of recording. However, in a conventional information recording and reproducing device, the recordable time basically depends on the capacity of the recording medium, not considering the setting (bit rate setting) of image quality and sound quality at the time of recording, thus raising a problem that the recordable time cannot be increased any further.

In the prior art disclosed in JP-A-11-176096, of video-recorded information, a “reproduction completed” flag is set for a management area once reproduced, and an archive flag is set for a management area not to be erased, so that only those management information with a reproduced flag set and with an archive flag not set is selected to extend the recordable time. However, in this case, the recordable time is extended by deleting recorded information permitted to be erased; therefore, the recordable time cannot be increased while saving recorded information under recording. Especially upon timer recording programming (timer video-recording programming), the recordable time is not increased while leaving already recorded information. In addition, the recordable time is not increased considering the setting of image quality and sound quality at the time of recording.

In the prior art disclosed in JP-A-2000-341627, at every predetermined period previously defined or when it is predicted that there will be no free space, transcoding means is actuated to reduce the capacity of a video audio signal saved in storage means to thereby generate some free space for data storage. Also in this prior art, especially upon timer video-recording programming, the recordable time is not increased considering the setting of image quality and sound quality at the time of recording.

In the prior art disclosed in JP-A-2001-94935, data once subjected to coding compression is compressed again and then stored into a storage device, and when the free space of the storage device becomes equal to or smaller than a first parameter previously specified, coding compression is performed on data of the storage device and the selection of a file subjected to transcoding is based on the importance level specified by the user. That is, in this prior art, coding compression is performed when the free space of the storage device becomes small. Especially upon timer video-recording programming, this prior art also does not increase the recordable time, considering the setting of image quality and sound quality at the time of recording.

In th prior art disclosed in JP-A-2003-235009, upon recording data on an information recording medium by way of timer video-recording, when TV programs worth the total programmed recording time overflow a non-recorded area subjected to recording, the management part executes recompression in accordance with an recompression flag. In addition, the order of genres preferred by the user is previously registered, and then, in accordance with this order, the management part automatically sets a recompression flag. That is, in this prior art, when those the programmed TV programs worth the total recording time overflow the non-recorded area, recompression is performed. Especially upon timer video-recording programming, this prior art also does not increase the recordable time considering the setting of image quality and sound quality at the time of recording.

### SUMMARY OF THE INVENTION

In view of such a problem, it is an object of the present invention to provide an information recording and reproducing device capable of, upon timer video-recording programming, increasing recordable time and also capable of increasing the recordable time considering the setting of image quality and sound quality at the time of recording.

To achieve the object described above, according to one aspect of the present invention, an information recording and reproducing device includes: a timer programming part that programs a timer recording for a desired TV program; and a recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the recorded data not with a minimum bit rate into data with a bit rate lower than a current bit rate so as to record new data on an area corresponding to a free space obtained as a result of the conversion.

In the information recording and reproducing device configured as described above, the recording extension processing part includes: residual space determination means that, when the timer programming part programs a timer for a desired TV program, determines whether or not the recording medium has a residual space equivalent to a capacity required for recording the TV program for which the timer is programmed; minimum bit rate determination means that, when the residual space determination means determines that the recording medium does not have an enough residual space, determines whether or not all data already recorded on the recording medium are data with a minimum bit rate; bit rate conversion means that, when the minimum bit rate determination means determines that not all the data are data with a minimum bit rate, converts the data not with a minimum bit rate into data with a bit rate lower than a current bit rate; and record means that records new data on an area corresponding to a free space obtained as a result of the bit rate conversion.

According to another aspect of the invention, an information recording and reproducing device includes: a timer programming part that programs a timer recording for a desired TV program; a first recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the data not with a minimum bit rate into data with a bit rate lower than a current bit rate so as to record new data on an area corresponding to a free space obtained as a result of the conversion; and a second recording extension processing part that, when it is selected to perform recording extension processing by the first recording extension processing part, if it is determined, for recorded data subjected to the recording extension processing, that a current recording bit rate is larger than a convertible bit rate and if it is determined that the recording medium has a free space equal to or larger than a capacity required for recording the TV program for which the timer is programmed, records new data on an area corresponding to the free space of the recording medium.

In the information recording and reproducing device described above, the first recording extension processing part includes: residual space determination means that, when the timer programming part programs a timer recording for a desired TV program, determines whether or not the recording medium has a residual space equivalent to a capacity required for recording the TV program for which the timer is programmed; minimum bit rate determination means that, when the residual space determination means determines that the recording medium does not have enough residual space, determines whether or not all data already recorded on the recording medium are data with a minimum bit rate; bit rate conversion means that, when the minimum bit rate determination means determines that not all the data are data with a minimum bit rate, converts the recorded data not with a minimum bit rate into data with a bit rate lower than a current bit rate; and first record means that records new data on an area corresponding to a free space obtained as a result of the bit rate conversion, and the second recording extension processing part includes: recording bit rate determination means that, when it is selected to perform recording extension processing by the first recording extension processing part, determines, for recorded data subjected to the recording extension processing, whether or not a current recording bit rate is equal to or lower than a convertible bit rate; free space determination means that, when the recording bit rate determination means determines that the current recording bit rate is larger than the convertible bit rate, determines whether or not a free space of the recording medium is equal to or larger than a capacity required for the TV program; and second record means that, when the free space determination means determines that the free space of the recording medium is equal to or larger than the capacity required for the TV program to be recorded, records new data on an area corresponding to the free space of the recording medium.

According to the present invention, there are provided: a timer programming part that programs a timer recording for a desired TV program; and a recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the recorded data not with a minimum bit rate into data with a bit rate lower than a current bit rate so as to record new data on an area corresponding to a free space obtained as a result of the conversion. Especially upon timer recording programming, when the recording medium does not have an enough residual space, the recorded data not with a minimum bit rate is converted into data with a bit rate lower than the current bit rate. This permits increasing the recordable time, thus improving the usability for the user.

According to the present invention, the recording extension processing part includes: residual space determination means that, when the timer programming part programs a timer for a desired TV program, determines whether or not the recording medium has a residual space equivalent to a capacity required for recording the TV program for which the timer is programmed; minimum bit rate determination means that, when the residual space determination means determines that the recording medium does not have an enough residual space, determines whether or not all data already recorded on the recording medium are data with a minimum bit rate; bit rate conversion means that, when the minimum bit rate determination means determines that not all the recorded data are data with a minimum bit rate, converts the recorded data not with a minimum bit rate into data with a bit rate lower than a current bit rate; and record means that records new data on an area corresponding to a free space obtained as a result of the bit rate conversion. Especially upon timer recording programming, when the recording medium does not have an enough residual space, the recorded data not with a minimum bit rate is converted into data with a bit rate lower than the current bit rate. This permits increasing the recordable time, thus improving the usability for the user.

According to the present invention, there are provided: a timer programming part that programs a timer recording for a desired TV program; a first recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the recorded data not with a minimum bit rate into data with a bit rate lower than a current bit rate so as to record new data on an area corresponding to a free space obtained as a result of the conversion; and a second recording extension processing part that, when it is selected to perform recording extension processing by the first recording extension processing part, if it is determined, for recorded data subjected to the recording extension processing, that a current recording bit rate is larger than a convertible bit rate and if it is determined that the recording medium has a free space equal to or larger than a capacity required for recording the TV program for which the timer is programmed, records new data on an area corresponding to the free space of the recording medium. Especially upon timer recording reservation, when the recording medium does have an enough residual space, the recorded data not with a minimum bit rate is converted into data with a bit rate lower than the current bit rate. This permits increasing the recordable time, thus improving the usability for the user. Moreover, especially upon timer recording programming, the recording extension processing performed by the first recording extension processing part can be achieved, considering the setting of image quality and sound quality at the time of recording, and thus the recordable time can be increased, considering the setting of image quality and sound quality at the time of recording, thus further improving the usability for the user. In particular, protection can be provided so that, even when recording extension processing is performed by the aforementioned first recording extension processing part, only particular data is not automatically subjected to bit rate level conversion, and also the user can determine the bit rate level that deteriorates when the recording quality deteriorates, thus improving the usability.

According to the present invention, the first recording extension processing part includes: residual space determination means that, when the timer programming part programs a timer recording for a desired TV program, determines whether or not the recording medium has a residual space equivalent to a capacity required for recording the TV program for which the timer is programmed; minimum bit rate determination means that, when the residual space determination means determines that the recording medium does not have enough residual space, determines whether or not all data already recorded on the recording medium are data with a minimum bit rate; bit rate conversion means that, when the minimum bit rate determination means determines that not all the recorded data are data with a minimum bit rate, converts the recorded data not with a minimum bit rate into data with a bit rate lower than a current bit rate; and first record means that records new data on an area corresponding to a free space obtained as a result of the bit rate conversion, and the second recording extension processing part includes: recording bit rate determination means that, when it is selected to perform recording extension processing by the first recording extension processing part, determines, for recorded data subjected to the recording extension processing, whether or not a current recording bit rate is equal to or lower than a convertible bit rate; free space determination means that, when the recording bit rate determination means determines that the current recording bit rate is larger than the convertible bit rate, determines whether or not a free space of the recording medium is equal to or larger than a capacity required for the TV program; and second record means that, when the free space determination means determines that the free space of the recording medium is equal to or larger than the capacity required for the TV program to be recorded, records new data on an area corresponding to the free space of the recording medium. Especially upon timer recording programming, when the recording medium does have an enough residual space, the recorded data not with a minimum bit rate is converted into data with a bit rate lower than the current bit rate. This permits increasing the recordable time, thus improving the usability for the user. Moreover, especially upon timer recording programming, the recording extension processing performed by the first recording extension processing part can be achieved, considering the setting of image quality and sound quality at the time of recording, and thus the recordable time can be increased, considering the setting of image quality and sound quality at the time of recording, thus further improving the usability for the user. In particular, protection can be provided so that, even when recording extension processing is performed by the aforementioned first recording extension processing part, only particular data is not automatically subjected to bit rate level conversion, and also the user can determine the bit rate level that deteriorates when the recording quality deteriorates, thus improving the usability.

### DESCRIPTION OF THE DRAWINGS

FIG. 1 is a block diagram showing the structure of a DVD recorder equipped with a hard disc as an information recording and reproducing device according to one embodiment of the present invention;

FIG. 2 is a flowchart for describing processing performed by a first recording extension processing part and a second recording extension processing part in the aforementioned embodiment; and

FIG. 3 is a flowchart for describing the processing performed by the second recording extension processing part in the aforementioned embodiment.

### DESCRIPTION OF THE PREFERRED EMBODIMENTS

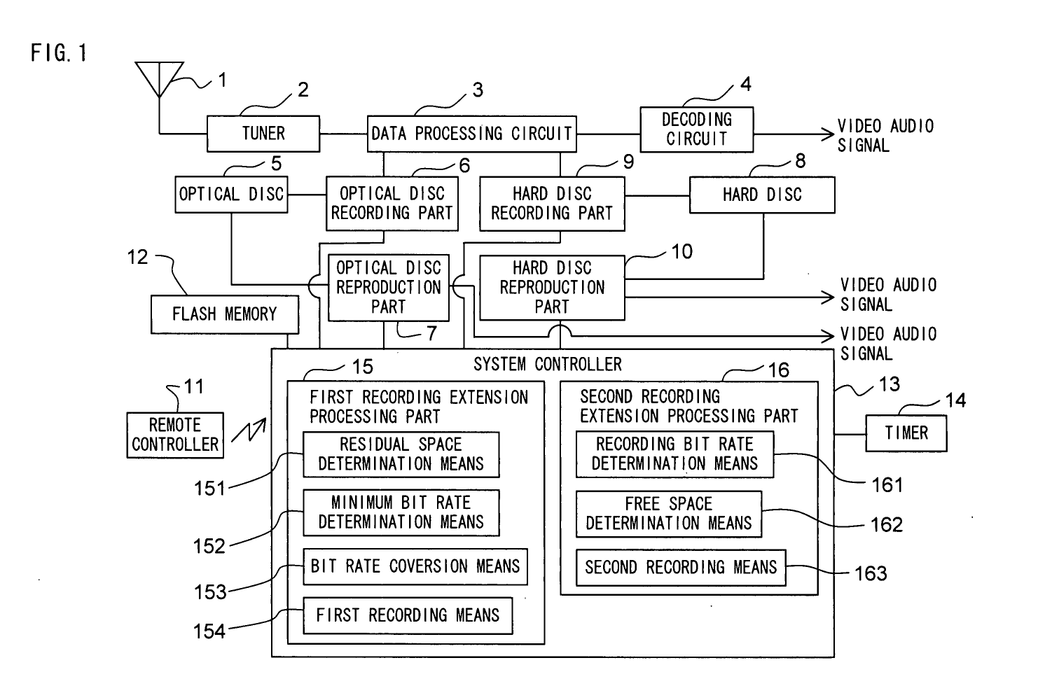

Hereinafter, with reference to the accompanying drawings, the embodiment of the present invention will be described. FIG. 1 is a block diagram showing the structure of a DVD recorder equipped with a hard disc as an information recording and reproducing device according to one embodiment of the present invention. The embodiment below will be described, referring to a DVD recorder equipped with a hard disc. However, the free space of an optical disc and a hard disc can also be increased by performing the same processing for a DVD recorder and a hard disc recorder.

In FIG. 1, this DVD recorder equipped with a hard disc includes: an antenna 1 connected to a tuner 2 for receiving a television broadcast signal; a data processing circuit 3 that performs digital processing on a broadcast signal selected by this tuner 2 and converts it into broadcast data in a form that can be recorded on an optical disc 5 or a hard disc 8 such as a DVD (digital versatile disc) or the like before outputting it; a decoding circuit 4 that decodes broadcast data from the data processing circuit 3 and outputs a video audio signal; an optical disc recording part 6 that inputs broadcast data from the data processing circuit 3 and records it on the optical disc 5 as video audio information or that records on the optical disc 5 video audio information reproduced from a hard disc reproduction part 10; and a hard disc recording part 9 that inputs broadcast data from the processing circuit 3 and records it on the hard disc 8 as video audio information or that records on the hard disc 8 video audio information reproduced from an optical disc reproduction part 7.

In addition, this DVD recorder includes: the aforementioned optical disc reproduction part 7 that reproduces video audio information recorded on optical disc 5; the aforementioned hard disc reproduction part 10 that reproduces video audio information recorded on the hard disc 8; a system controller 13 that controls the entire system; a flash memory 12 that stores a program and data required for control and processing of this system controller 13; a timer 14 for achieving timer programming function; and a remote controller 11 that transmits an operation signal to the system controller 13 by infrared.

The system controller 13 includes a first recording extension processing part 15 having: residual space determination means 151 that, when a timer is programmed for a desired TV program, determines whether or not the optical disc 5 or the hard disc 8 has a residual space equivalent to the capacity required for recording the aforementioned TV program for which a timer is programmed; minimum bit rate determination means 152 that, when this residual space determination means 151 has determined that the optical disc 5 or the hard disc 8 does not have an enough residual space, determines whether or not all the data already recorded on the optical disc 5 or the hard disc 8 are data with a minimum bit rate; bit rate conversion means 153 that, when this minimum bit rate determination means 152 has determined that not all the aforementioned recorded data are data with a minimum bit rate, converts the recorded data not with a minimum bit rate into data with a bit rate lower than the current bit rate; and first record means 154 that records new data on an area corresponding to a free space of the optical disc 5 or the hard disc 8 obtained by the aforementioned bit rate conversion

The system controller 13 includes a second recording extension processing part 16 having: recording bit rate determination means 161 that, when it is selected to perform recording extension processing by the aforementioned first recording extension processing part 15, determines, for recorded data subjected to the recording extension processing, whether or not the current recording bit rate is equal to or smaller than the convertible bit rate; free space determination means 162 that, when this recording bit rate determination means 161 has determined that the current recording bit rate is larger than the convertible bit rate, determines whether or not the free space of the optical disc 5 or the hard disc 8 is equal to or larger than the capacity required for the aforementioned TV program to be recorded; and second record means 163 that, when this free space determination means 162 has determined that the aforementioned free space is equal to or larger than the capacity required for the aforementioned TV program to be recorded, records new data on an area corresponding to the aforementioned free space.

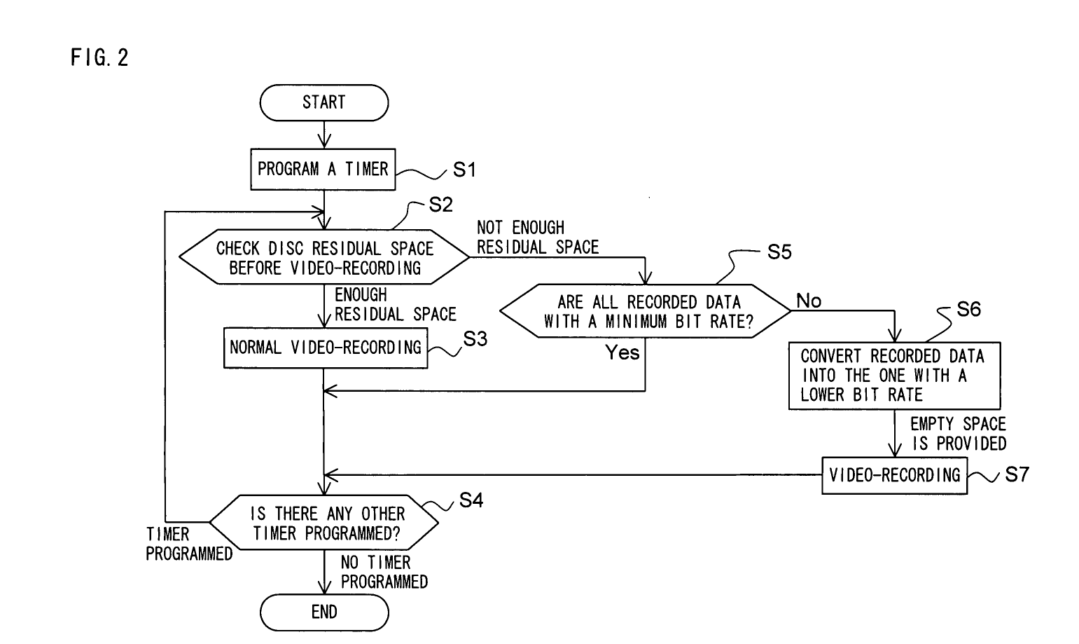

FIG. 2 is a flowchart for describing the processing performed by the first recording extension processing part 15 in this embodiment. Referring to this flowchart, the processing performed by the first recording extension processing part 15 will be described. In this flowchart, video-recording denotes recording video data and audio data.

In the first recording extension processing part 15, for the purpose of, for example, programming video-recording for a desired TV program on the optical disc 5, the user loads the optical disc 5 and operates the remote controller 11 to program a timer (step S1), upon which the residual space determination means 151 drives the optical disc reproduction part 7 to read disc information from the optical disc 5 and determines whether or not the disc has a residual space equivalent to the capacity required for the video-recording of the aforementioned TV program for which the timer programming has been set. That is, before video-recording (not immediately before video-recording, but with a sufficient period before video-recording), the residual space determination means 151 checks the residual space of the optical disc 5 to determine whether or not the disc has an enough residual space (step S2).

Then, when the residual space determination means 151 has determined that the disc does not have an enough residual space equivalent to the capacity required for the video-recording of the aforementioned TV program for which the timer is programmed, the minimum bit rate determination means 152 determines whether or not all the data already video-recorded on the optical disc 5 are data with a minimum bit rate (minimum image quality) (step S5). When the minimum bit rate determination means 152 has determined that not all the video-recorded data are data with a minimum bit rate, the bit rate conversion means 153 converts the video-recorded data not with a minimum bit rate into data with a bit rate lower than the current bit rate (step S6), and then the first record means 154 video-records new data on an area corresponding to a free space obtained as a result of the aforementioned bit rate conversion (step S7).

In step S2, when the residual space determination means 151 has determined that the disc has an enough residual space, normal video-recording is performed (step S3). When there is any other timer programmed (step S4), the processing returns to step S2, and when there is no other timer programmed (step S4), the processing ends. In step S5, when the minimum bit rate determination means 152 has determined that all the video-recorded data are data with a minimum bit rate or when there is any other timer recording programmed after the video-recording performed in step S7 (step S4), the processing returns to step S2, and when there is no other timer recording programmed (step S4), the processing ends.

According to the processing performed by this first recording extension processing part 15, especially upon timer video-recording programming, when the recording medium concerned does not have an enough residual space, recorded data not with a minimum bit rate is converted into data with a bit rate lower than the current bit rate. This permits increasing the recordable time, thus improving the usability for the user.

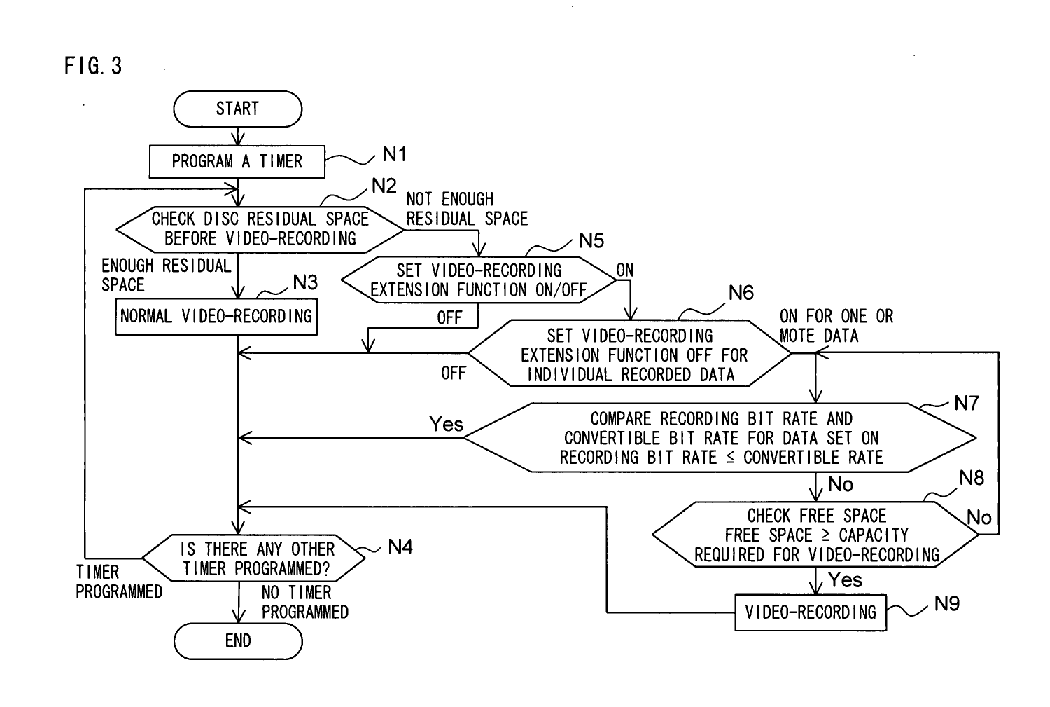

FIG. 3 is a flowchart for describing the processing performed by the first recording extension processing part 15 and the second recording extension processing part 16 in this embodiment. Referring to this flowchart, the processing performed by the first recording extension processing part 15 and the second recording extension processing part 16 will be described. Note that, also in this flowchart, video-recording denotes recording video data and audio data.

In the first recording extension processing part 15, for the purpose of, for example, programming a video-recording for a desired TV program on the optical disc 5, the user loads the optical disc 5 and operates the remote controller 11 to program a timer (step N1), upon which the residual space determination means 151 drives the optical disc reproduction part 7 to read disc information from the optical disc 5 and determines whether or not the disc has a residual space equivalent to the capacity required for the video-recording of the aforementioned TV program for which the timer has been programmed. That is, before video-recording (not immediately before video-recording, but with a sufficient period before video-recording), the residual space determination means 151 checks the capacity, ie., the residual space, of the optical disc 5 to determine whether or not the disc has an enough residual space (step N2).

Then, when the residual space determination means 151 has determined that the disc does not have an enough residual space equivalent to the capacity required for the video-recording of the aforementioned TV program for which the timer has been programmed, the user is prompted to select whether or not to execute the processing performed by the aforementioned first recording extension processing part 15 (step N5). More specifically, the setup information is displayed on the TV screen, the user is prompted to select between ON and OFF for the video-recording extension function included in the setup information, since the video-recording extension processing performed by the first recording extension processing part 15 is executed by setting the video-recording extension function ON while the video-recording extension processing performed by the first recording extension processing part 15 is not executed by setting the video-recording extension function OFF.

When ON is selected for the video-recording extension function, the user is prompted to select whether to set the video-recording extension function OFF for all individual video-recorded data or to set the video-recording extension function ON for at least one of these individual data (step N6). Then, when it is selected to set the video-recording extension function ON for one of the individual data, comparison between the recording bit rate and the convertible bit rate is made for the data for which the video-recording extension function is set ON (step N7). More specifically, the recording bit rate determination means 161 determines, for the video-recorded data subjected to the video-recording extension processing, whether or not the current recording bit rate is equal to or smaller than the convertible bit rate.

When the recording bit rate determination means 161 has determined that the current recording bit rate is larger than the convertible bit rate (step N7), the free space determination means 162 checks the free space, and determines whether or not the free space of the optical disc 5 is equal to or larger than the capacity required for the video-recording of the aforementioned TV program for which the timer has been programmed (step N8). The processing at step N7 and step N8 is repeated until the free space of the optical disc 5 becomes equal to or larger than the capacity required for the video-recording of the aforementioned TV program for which the timer has been programmed. Then, when the free space determination means 162 has determined that the free space of the optical disc 5 is equal to or larger than the capacity required for the video-recording of the aforementioned TV program for which the timer recording has bee made, the second record means 163 performs video-recording (recording) of new data on an area corresponding to the free space of the optical disc 5 (step N9).

In step N2, when the residual space determination means 151 has checked the residual space of the optical disc and has determined that the disc has an enough residual space, normal video-recording is performed (step N3). When there is any other timer programmed (step N4), the processing returns to step N2, and when there is no other timer programmed (step N4), the processing ends. When OFF is set for the video-recording extension function in step N5, or when OFF is set for the video-recording extension function for all the data in step N6, or when the recording bit rate determination means 161 has determined that the current recording bit rate is larger than the convertible bit rate in step N7, or after video-recording is performed in step N9 (step N4), the processing returns to step N2 when there is any other timer programmed, and the processing ends when there is no other timer programmed (step N4).

According to the processing performed by this second recording extension processing part 16, especially upon timer recording programming, the recording extension processing performed by the first recording extension processing part 15 can be achieved, considering the setting of image quality and sound quality at the time of recording, and thus the recordable time can be increased, considering the setting of image quality and sound quality at the time of recording, thus further improving the usability for the user. In particular, protection can be provided so that, even when recording extension processing is performed by the aforementioned first recording extension processing part 15, only particular data is not automatically subjected to bit rate level conversion, and also the user can determine the bit rate level that deteriorates when the recording quality deteriorates, thus improving the usability.

In the embodiment descried above, the bit rate of video data to be recorded is changed in a decreasing direction to thereby increase the free space of the optical disc. The bit rate of audio data to be recorded may also be changed in a decreasing direction to thereby increase the free space of the optical disc. This, however, does not provide a tremendous effect on audio data, which is smaller in data volume than video data, but contributes to ensuring some free space in, for example, compressing a linear PCM audio signal into a Dolby audio signal.

What is claimed is:

1. An information recording and reproducing device comprising:
a timer programming part that programs a timer recording for a desired TV program; and
a recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the data not with a minimum bit rate into data with a bit rate lower than a current bit rate so as to record new data on an area corresponding to a free space obtained as a result of the conversion.

2. The information recording and reproducing device according to claim 1, wherein the recording extension processing part comprises:
residual space determination means that, when the timer programming part programs a timer for a desired TV program, determines whether or not the recording medium has a residual space equivalent to a capacity required for recording the TV program for which the timer is programmed;
minimum bit rate determination means that, when the residual space determination means determines that the recording medium does not have an enough residual space, determines whether or not all data already recorded on the recording medium are data with a minimum bit rate;
bit rate conversion means that, when the minimum bit rate determination means determines that not all the data are data with a minimum bit rate, converts the data not with a minimum bit rate into data with a bit rate lower than a current bit rate; and
record means that records new data on an area corresponding to a free space obtained as a result of the bit rate conversion.

3. An information recording and reproducing device comprising:
a timer programming part that programs a timer recording for a desired TV program;
a first recording extension processing part that, when the timer programming part programs a timer for a desired TV program, if it is determined that a recording medium as an optical disc or/and a hard disc does not have an enough residual space and if it is determined that not all data already recorded on the recording medium are data with a minimum bit rate, converts the data not with a minimum bit rate into data with a bit rate lower than a current bit rate so as to record new data on an area corresponding to a free space obtained as a result of the conversion; and
a second recording extension processing part that, when it is selected to perform recording extension processing by the first recording extension processing part, if it is determined, for recorded data subjected to the recording extension processing, that a current recording bit rate is larger than a convertible bit rate and if it is determined that the recording medium has a free space equal to or larger than a capacity required for recording the TV program for which the timer is programmed, records new data on an area corresponding to the free space of the recording medium.

4. The information recording and reproducing device according to claim 3, wherein the first recording extension processing part comprises:
residual space determination means that, when the timer programming part programs a timer recording for a desired TV program, determines whether or not the recording medium has a residual space equivalent to a capacity required for recording the TV program for which the timer is programmed;
minimum bit rate determination means that, when the residual space determination means determines that the recording medium does not have enough residual space, determines whether or not all data already recorded on the recording medium are data with a minimum bit rate;
bit rate conversion means that, when the minimum bit rate determination means determines that not all the data are data with a minimum bit rate, converts the recorded data not with a minimum bit rate into data with a bit rate lower than a current bit rate; and
first record means that records new data on an area corresponding to a free space obtained as a result of the bit rate conversion, and
wherein the second recording extension processing part comprises:
recording bit rate determination means that, when it is selected to perform recording extension processing by the first recording extension processing part, determines, for recorded data subjected to the recording extension processing, whether or not a current recording bit rate is equal to or lower than a convertible bit rate;
free space determination means that, when the recording bit rate determination means determines that the current recording bit rate is larger than the convertible bit rate, determines whether or not a free space of the recording medium is equal to or larger than a capacity required for the TV program; and
second record means that, when the free space determination means determines that the free space of the recording medium is equal to or larger than the capacity required for the TV program to be recorded, records new data on an area corresponding to the free space of the recording medium.
